(19) United States
(12) Patent Application Publication
(10) Pub. No.: US 2019/0317917 A1
(43) Pub. Date: Oct. 17, 2019

(54) STORAGE APPARATUS AND NON-TRANSITORY RECORDING MEDIUM

(71) Applicant: FUJITSU LIMITED, Kawasaki-shi (JP)

(72) Inventors: Shinichi Nishizono, Kawasaki (JP); Hidenori Yamada, Kita (JP); Masanori Furuya, Kawasaki (JP); Koichi Hayashi, Ota (JP)

(73) Assignee: FUJITSU LIMITED, Kawasaki-shi (JP)

(21) Appl. No.: 16/288,426

(22) Filed: Feb. 28, 2019

(30) Foreign Application Priority Data
Apr. 17, 2018 (JP) 2018-079206

(51) Int. Cl. G06F 16/11; G06F 11/14

(52) U.S. Cl. CPC G06F 16/128; G06F 11/1469

(57) ABSTRACT

A storage apparatus includes a memory, and a processor coupled to the memory and configured to, upon reception of an instruction to restore a copy source volume of a copy source storage apparatus that includes the copy source volume and a first volume on which a first snapshot of the copy source volume is created, make a determination as to whether remote copying of the first snapshot to a copy destination volume of a copy destination storage apparatus is completed and the copy destination volume is equivalent to the first volume, the copy destination storage apparatus including the copy destination volume onto which the remote copying is performed and including a second volume on which a second snapshot of the copy destination volume is created, and configured to decide, based on a result of the determination, a restoration source volume from the copy destination volume and the second volume.

### CROSS-REFERENCE TO RELATED APPLICATIONS

This application is based on and claims priority to Japanese Patent Application No. 2018-079206, filed on Apr. 17, 2018, the entire contents of which are incorporated herein by reference.

### FIELD

The disclosures herein relate to a storage apparatus and a non-transitory recording medium.

### BACKGROUND

Conventionally, as a countermeasure to prevent data of a business volume from being lost due to a disaster, for example, a storage apparatus uses a copy function to back up data to a remote site. If the data is copied directly from the business volume to a volume of a remote storage apparatus, input/output (I/O) performance of the business volume may be affected. Thus, there may be cases where a snapshot of the business volume, namely a copy of data of the business volume at a given point in time is created in a duplicate volume located in the same storage apparatus as the business volume in order to transfer data of the duplicate volume to the remote storage apparatus.

In the related art, there is a technique that mirrors data of a primary storage located at a first location onto a secondary storage located at a second location, takes snapshots of the primary storage and snapshots of the secondary storage, and stores the snapshots of the primary storage in first snapshot volumes and the snapshots of the secondary storage in second snapshot volumes. There is also a technique in which a primary processing apparatus relays a request for creating a snapshot of or for copying at least a part of a primary volume to a secondary storage subsystem, and in response to the relayed request, a secondary processing apparatus creates a snapshot of or copies a corresponding part of a secondary volume.

### RELATED-ART DOCUMENTS

### Patent Documents

### [Patent Document 1] Japanese Laid-open Patent Publication No. 2003-242011

### [Patent Document 2] Japanese Laid-open Patent Publication No. 11-259348

However, the conventional techniques have a problem in that restoration work takes time and effort. For example, when restoring data of a copy source after a failure occurs, it takes time to determine from which volume to restore the data. This may prolong time required for data recovery.

### SUMMARY

According to an aspect of the embodiment, a storage apparatus includes a memory, and a processor coupled to the memory and configured to, upon reception of an instruction to restore a copy source volume of a copy source storage apparatus that includes the copy source volume and a first volume on which a first snapshot of the copy source volume is created, make a determination as to whether remote copying of data of the first snapshot to a copy destination volume of a copy destination storage apparatus is completed and the copy destination volume is equivalent to the first volume, the copy destination storage apparatus including the copy destination volume onto which the remote copying is performed and including a second volume on which a second snapshot of the copy destination volume is created, and based on a result of the determination, decide, from the copy destination volume and the second volume, a restoration source volume from which data of the copy source volume is restored.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of hardware configurations of storage apparatuses according to an embodiment;

FIG. 2 is a diagram illustrating an example of data backup;

FIGS. 3A through 3C are diagrams illustrating examples of data restoration;

FIG. 4A is a table illustrating an example of information stored in a copy session table 400 (P);

FIG. 4B is a table illustrating an example of information stored in a copy session table 400 (S);

FIG. 5A is a table illustrating an example of information stored in a session relationship table 500 (P);

FIG. 5B is a table illustrating an example of information stored in a session relationship table 500 (S);

FIG. 6 is a block diagram illustrating an example of a functional configuration of a storage apparatus 101;

FIGS. 7A and 7B are tables illustrating examples of the updated copy session tables 400;

FIGS. 8A and 8B are tables illustrating examples of the updated session relationship table 500;

FIGS. 9A and 9B are tables illustrating examples of the updated copy session tables 400;

FIG. 10 is a flowchart illustrating an example of a backup process performed by the storage apparatus 101;

FIG. 11 is a flowchart illustrating an example of a restoration process performed by the storage apparatus 101; and

FIG. 12 is a flowchart illustrating an example of a post-restoration process performed by the storage apparatus 101.

### DESCRIPTION OF EMBODIMENTS

According to at least one aspect of the present invention, it is possible to reduce the burden of restoration work.

In the following, embodiments of a storage apparatus and a non-transitory recording medium according to the present invention will be described with reference to the accompanying drawings.

### EMBODIMENTS

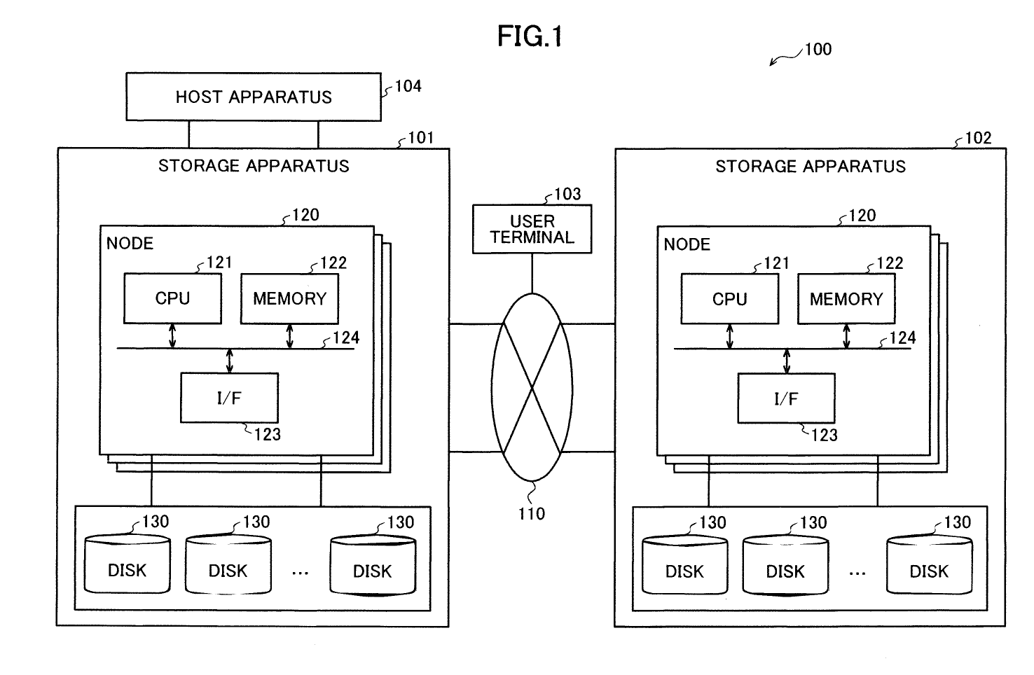

FIG. 1 is a diagram illustrating an example of hardware configurations of storage apparatuses according to an embodiment. In FIG. 1, a storage system 100 includes a storage apparatus 101, a storage apparatus 102, and a user terminal 103. In the storage system 100, the storage apparatus 101, the storage apparatus 102, and the user terminal 103 are connected to each other via a wired or wireless network 110. Examples of the network 110 include a local area network (LAN), a wide area network (WAN), and the Internet.

The storage apparatus 101 is a copy source storage apparatus in which data to be backed up is stored. The storage apparatus 102 is a copy destination storage apparatus to which the data to be backed up is copied. The user terminal 103 is a computer used by a user of the storage system 100.

The user terminal 103 sends a backup instruction and a restoration instruction in accordance with the user's input operation. For example, the user terminal 103 is a personal computer (PC). The host apparatus 104 is a host computer connected to the storage system 100. For example, the host apparatus 104 uses a volume created in the storage apparatus 101 to perform a business process.

The storage apparatuses 101 and 102 each have a remote copy function. The remote copy function is a function that enables remote copying between apparatuses. For example, in order to periodically transfer data of a copy source (volume) to a copy destination (volume) in remote copying, data of the copy source is transferred to the copy destination first, and updated data is sequentially transferred to the copy destination.

The storage apparatuses 101 and 102 each include at least one node 120 and at least one disk 130. The node 120 is a control unit that performs resource management of the disk 130 and a memory 122, copy control, and the like. The node 120 includes a central processing unit (CPU) 121, the memory 122, and an interface (I/F) 123. Also, these elements are coupled to each other via a bus 124.

The CPU 121 performs control of the entire node 120. The CPU 121 may include a plurality of cores. The memory 122 includes dynamic random-access memory (DRAM) and flash read only memory (ROM), for example. To be more specific, the flash ROM stores various types of programs. The DRAM is a volatile memory used as a work area of the CPU 121. For example, the DRAM stores user data and control information being processed. A program stored in the memory 122 is loaded onto the CPU 121 so as to cause the CPU 121 to execute a coded process.

The I/F 123 is connected to the network 110, and is connected to another computer via the network 110. The I/F 123 functions as an interface between the network 110 and the elements inside the node, and controls data input/output to/from the other computer. As the I/F 123, a channel adapter (CA) and a LAN adapter may be employed.

The disk 130 is an example of storage that stores data, and is a non-volatile storage apparatus that stores user data and control information. The disk 130 is, for example, a hard disk drive (HDD) or a solid state drive (SDD). The disk 130 may be entirely a HDD or a SSD, or may include a HDD and a SSD in combination.

### (Example of Data Backup)

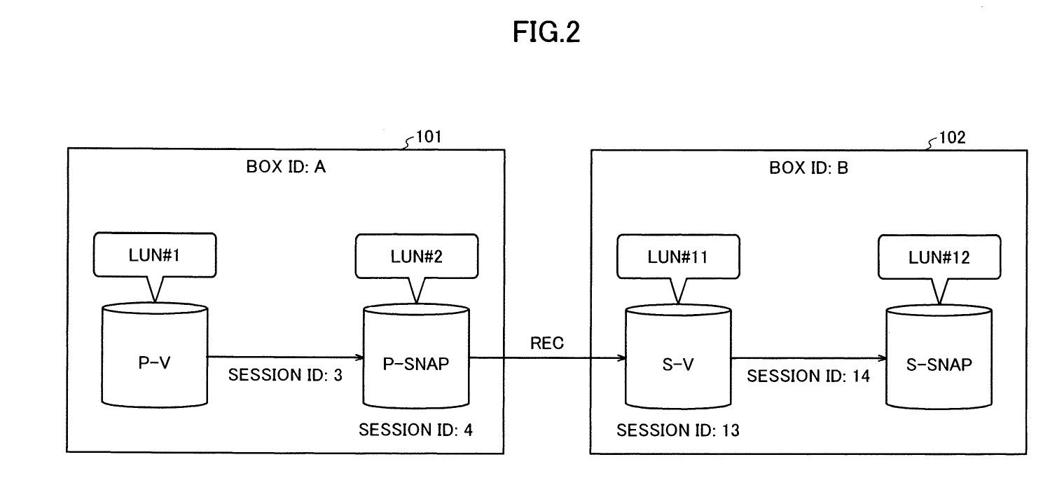

Next, referring to FIG. 2, an example of data backup in the storage system 100 will be described. In this example, data is backed up by remotely copying data of the storage apparatus 101 to the storage apparatus 102.

FIG. 2 is a diagram illustrating an example of data backup. In FIG. 2, a box ID is an identifier for identifying each of the storage apparatuses 101 and 102. The box ID of the storage apparatus 101 is “A”, and the box ID of the storage apparatus 102 is “B”.

A volume (P-V) is a copy source volume created in the storage apparatus 101. A volume is a storage space as a management unit of each of the storage apparatuses 101 and 102. A volume may be one or more physical storage apparatuses, or may be a logical unit number (LUN) as a logical storage apparatus. For example, the volume (P-V) may be a business volume.

In the example of FIG. 2, the volume (P-V) is a LUN#1. A (number) of a LUN#(number) represents a volume ID. The volume ID is an identifier for uniquely identifying a volume of each of the storage apparatuses 101 and 102. A volume (S-V) is a copy destination volume created in the storage apparatus 102. In the example of FIG. 2, the volume (S-V) is a LUN#11.

It is noted that P-V is the abbreviation for a primary volume, and S-V is the abbreviation for secondary volume.

For data backup from the volume (P-V) to the volume (S-V), if data were to be copied directly from the volume (P-V) to the volume (S-V), I/O performance of the volume (P-V) would be affected. Thus, the storage apparatus 101 creates a snapshot of the volume (P-V) on a volume (P-Snap) of the storage apparatus 101 itself, and remote copying from the volume (P-Snap) to the volume (S-V) is performed.

A snapshot is a logical copy of data at a given point in time. For example, a snapshot is created by what is known as a copy-on-write technique that, before an update is made to data, creates a copy of a data portion that is to be updated, and retains the data portion together with a non-updated data portion of the original data. In the example of FIG. 2, the volume (P-Snap) is a LUN#2.

Further, if a communication failure were to occur during remote copying from the volume (P-Snap) to the volume (S-V), the volume (S-V) and the volume (P-Snap) would not become equivalent, which might cause the volume (S-V) to be unable to be used. In order to avoid this, the storage apparatus 102 creates a snapshot of the volume (S-V) on a volume (S-Snap) of the storage apparatus 102 itself after remote copying from the volume (P-Snap) to the volume (S-V) is completed. In the example of FIG. 2, the volume (S-Snap) is a LUN#12.

Accordingly, it is possible to back up data of the volume (P-V) while preventing I/O performance of the volume (P-V) from being affected. Further, it is also possible to back up data of the volume (S-V) at the remote site by taking into account a communication failure during remote copying.

In FIG. 2, a session ID is an identifier for identifying a copy session. A copy session represents a copy execution unit. REC represents remote copying.

However, in a configuration in which data backup is performed as illustrated in FIG. 2, in order to restore data of a copy source after a failure occurs, it would be difficult for a user to manually determine from which volume to restore the data. Restoration means, when data is lost, the restoring of the lost data by using backup data.

For example, it would take time and effort for a user to check the status of each volume one by one in order to determine from which volume to restore data. This may prolong time required for data recovery. Also, depending on the user, the volume from which to restore data would not be properly determined.

In light of the above, according to the present embodiment, when restoring data of the volume (P-V), the storage apparatus 101 automatically decides a restoration source volume from the volume (P-Snap), the volume (S-V), and the volume (S-Snap), in order to reduce the user's burden of restoration work.

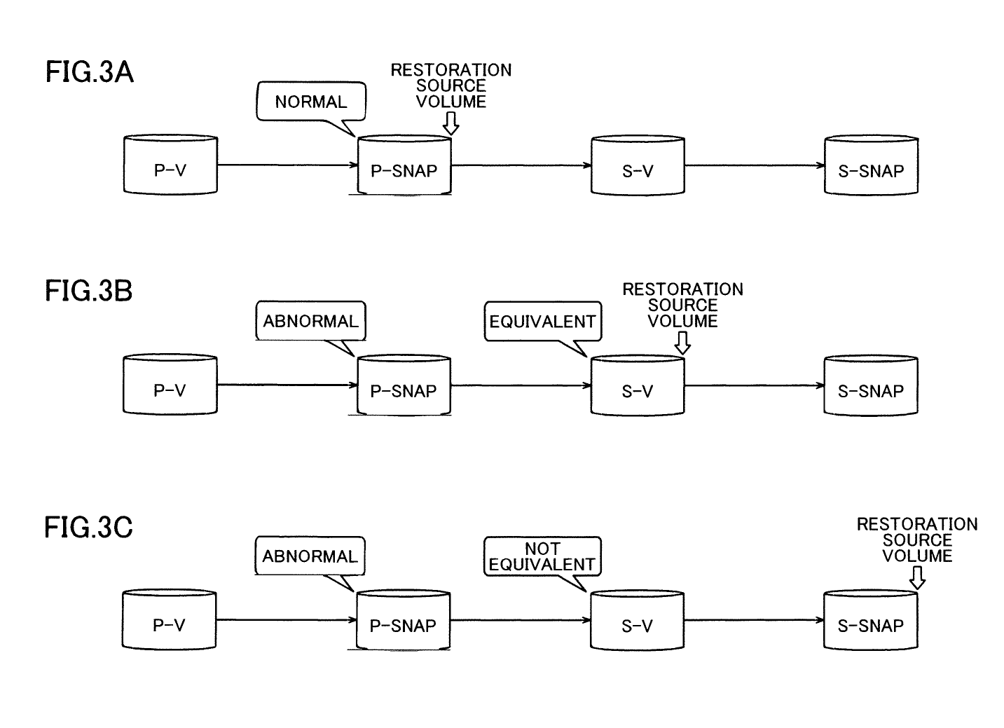

Referring now to FIGS. 3A through 3C, examples of data restoration will be described.

FIGS. 3A through 3C are diagrams illustrating examples of data restoration. In FIGS. 3A through 3C, upon receiving an instruction to restore the volume (P-V), the storage apparatus 101 decides a restoration source volume from which to restore data of the volume (P-V), in accordance with any one of conditions (a), (b), and (c) below.

The condition (a) is that the status of a snapshot created on the volume (P-Snap) is normal. When the condition (a) is determined to be applied, the storage apparatus 101 decides the volume (P-Snap) as the restoration source volume, from among the volume (P-Snap), the volume (S-V), and the volume (S-Snap).

Accordingly, when the status of a snapshot created on the volume (P-Snap) is normal, data of the volume (P-V) can be restored from the volume (P-Snap) located at the same site. For example, in the case of a failure due to human error such as data deletion, the status of a snapshot created on the volume (P-Snap) would be normal. In this case, data of the volume (P-V) can be restored from the volume (P-Snap) located at the same site.

The condition (b) is that the status of a snapshot created on the volume (P-Snap) is abnormal and the volume (S-V) is equivalent to the volume (P-Snap). When the condition (b) is determined to be applied, the storage apparatus 101 decides the volume (S-V) as a restoration source volume, from among the volume (P-Snap), the volume (S-V), and the volume (S-Snap).

The term “equivalent” means that the previous remote copying from the volume (P-Snap) to volume (S-V) is successfully completed and it is assured that data stored on the volume (S-V) is equivalent to the volume (P-Snap). Namely, the above condition (b) is applied if a hardware failure such as a disk fault occurs in the storage apparatus 101 after the previous remote copying from the volume (P-Snap) to the volume (S-V) is successfully completed.

Accordingly, data of the volume (P-V) can be restored from the volume (S-V) if a hardware failure such as a disk fault occurs in the storage apparatus 101 after the previous remote copying from the volume (P-Snap) to the volume (S-V) is successfully completed.

The condition (c) is that the status of a snapshot created on the volume (P-Snap) is abnormal and the volume (S-V) is not equivalent to the volume (P-Snap). When the condition (c) is determined to be applied, the storage apparatus 101 decides the volume (S-Snap) as the restoration source volume, from among the volume (P-Snap), the volume (S-V), and the volume (S-Snap).

Accordingly, data of the volume (P-V) can be restored from the volume (S-Snap) if a failure such as a disk fault occurs in the storage apparatus 101 while remote copying from the volume (P-Snap) to the volume (S-V) is being performed.

For example, when a snapshot of the volume (P-V) is frequently created, namely when the volume (P-V) is backed up at short time intervals, the condition (c) is more likely to be applied than the condition (b).

In this way, the storage apparatus 101 can decide, from the volume (P-Snap), the volume (S-V), and the volume (S-Snap), the restoration source volume from which to restore data of the volume (P-V), depending on what failure occurs in what situation. Accordingly, it is possible to restore data of the volume (P-V) without requiring a user to determine from which volume, the data needs to be restored. As a result, the user's burden of restoration work can be reduced.

### (Information Stored in Copy Session Tables 400)

Next, information stored in copy session tables 400 included in the respective storage apparatuses 101 and 102 will be described. The copy session tables 400 are stored, for example, in the memory 122 of the node 120 or in the disk 130 within the respective storage apparatuses 101 and 102.

In the following description, the copy session table 400 included in the storage apparatus 101 may be referred to as a “copy session table 400 (P)”, and the copy session table 400 included in the storage apparatus 102 may be referred to as a “copy session table 400 (S)”.

First, information stored in the copy session table 400 (P) included in the storage apparatus 101 will be described.

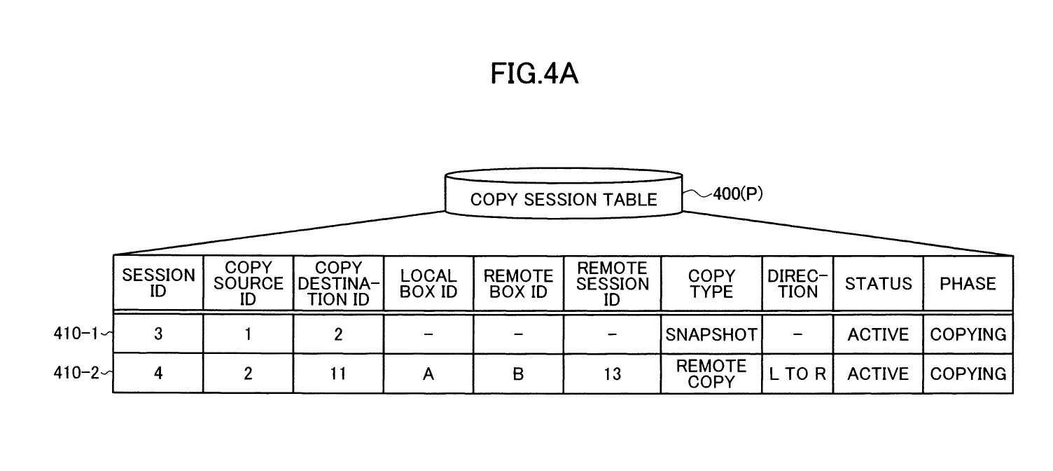

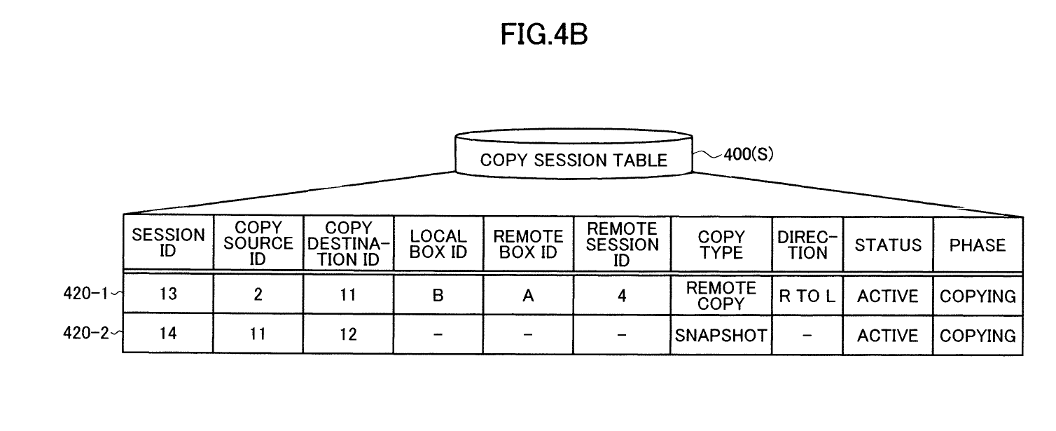

FIG. 4A is a table illustrating an example of information stored in the copy session table 400 (P). In the FIG. 4A, the copy session table 400 (P) includes “session ID”, “copy source ID”, “copy destination ID”, “local box ID”, “remote box ID”, “remote session ID”, “copy type”, “direction”, “status”, and “phase” fields. Copy session information 410-1 and copy session information 410-2 are stored as records by setting information in each of the fields.

The “session ID” is an identifier for identifying a copy session. The “copy source ID” is a volume ID of a copy source volume. The “copy destination ID” is a volume ID of a copy destination volume. The “local box ID” is a box ID of the storage apparatus itself. The “remote box ID” is a box ID of the other storage apparatus. The “remote session ID” is a session ID of remote copying and is used in the other storage apparatus.

The “copy type” indicates a copy type. Either “snapshot” or “remote copy” is set in the “copy type” field. The copy type “snapshot” represents a snapshot. The copy type “remote copy” represents remote copying. The direction is a direction of remote copying. A direction “L to R” indicates a direction from the local site (the storage apparatus itself) to the remote site (the other storage apparatus). A direction “R to L” indicates a direction from the remote site (the other storage apparatus) to the local site (the storage apparatus itself).

The “status” indicates the status of a copy session. For a copy session with the copy type “snapshot”, either “active” or “error” is set in the “status” fields. For a copy session with the copy type “remote copy”, any one of “active”, “suspend”, and “error” is set in the “status” fields. The status “active” indicates that the status of a copy session is normal. The status “suspend” indicates that a copy session is being stopped. The status “error” indicates that the status of a copy session is abnormal.

The “phase” indicates that a copy is in progress or is completed. For a copy session with copy type “snapshot”, “copying” is set in the “phase” field. For a copy session with the copy type “remote copy”, either “copying” or “equivalent” is set in the “phase” field. The phase “copying” indicates that copying is in progress. The phase “equivalent” indicates that copying is completed and equivalency is maintained. The local box ID, the remote box ID, and the remote session ID are set only for remote copying.

Next, information stored in the copy session table 400 (S) included in the storage apparatus 102 will be described.

FIG. 4B is a table illustrating an example of information stored in the copy session table 400 (S). In the FIG. 4B, the copy session table 400 (S) includes “session ID”, “copy source ID”, “copy destination ID”, “local box ID”, “remote box ID”, “remote session ID”, “copy type”, “direction”, “status”, and “phase” fields. Copy session information 420-1 and copy session information 420-2 are stored as records by setting information in each of the fields.

Details of the copy session table 400 (S) are similar to those of the copy session table 400 (P) illustrated in FIG. 4A, and thus, a description thereof will be omitted.

### (Information Stored in Session Relationship Tables 500)

Next, information stored in session relationship tables 500 included in the respective storage apparatuses 101 and 102 will be described. The session relationship tables 500 are stored, for example, in the memory 122 of the node 120 or in the disk 130 within the respective storage apparatuses 101 and 102.

In the following description, the session relationship table 500 included in the storage apparatus 101 may be referred to as a “session relationship table 500 (P)”, and the session relationship table 500 included in the storage apparatus 102 may be referred to as a “session relationship table 500 (S)”.

First, information stored in the session relationship table 500 (P) included in the storage apparatus 101 will be described.

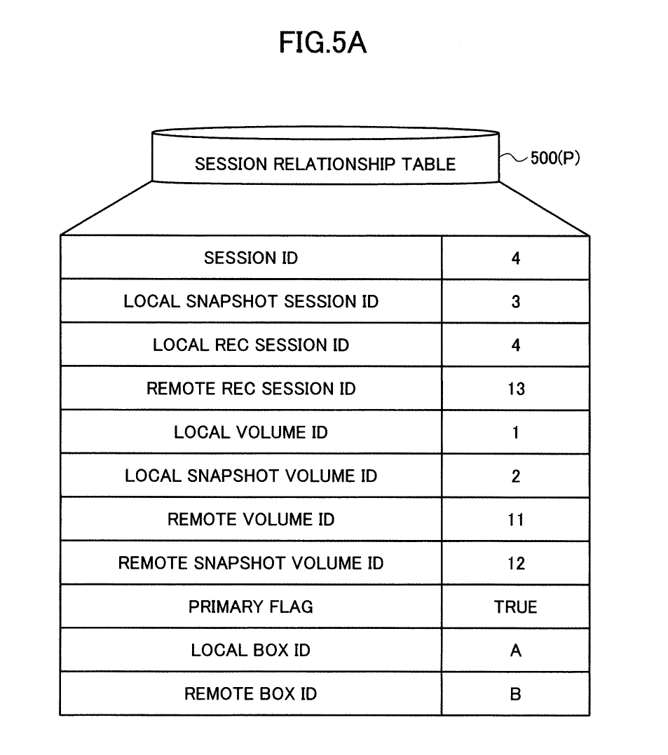

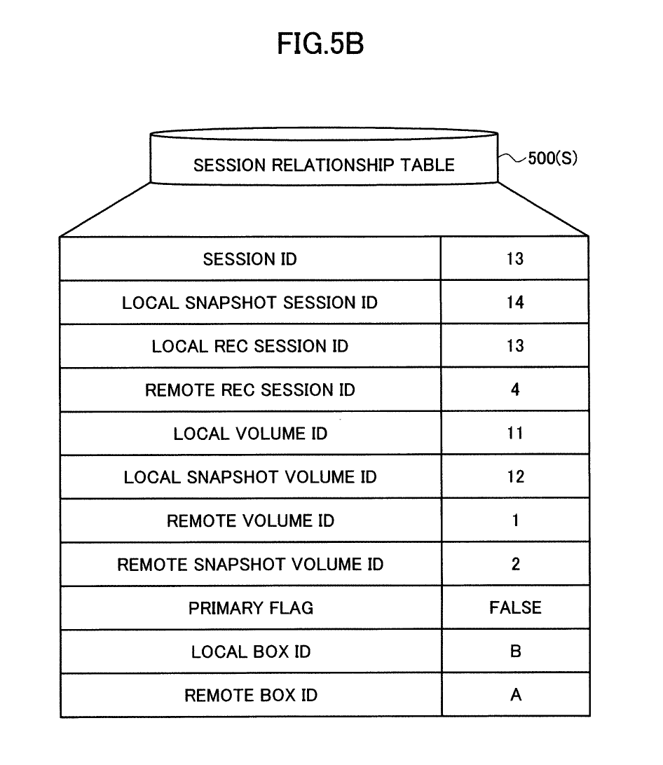

FIG. 5A is a table illustrating an example of information stored in the session relationship table 500 (P). In FIG. 5A, the session relationship table 500 (P) stores a relationship between copy sessions created when data backup is performed between the storage apparatuses 101 and 102.

To be more specific, the session relationship table 500 (P) stores a session ID, a local snapshot session ID, a local REC session ID, a remote REC session ID, a local volume ID, a local snapshot volume ID, a remote volume ID, a remote snapshot volume ID, a primary flag, a local box ID, and a remote box ID in association with each other.

The session ID is a session ID of a copy session. The local snapshot session ID is a session ID of a copy session with the copy type “snapshot” at the local site (in the storage apparatus itself). The local REC session ID is a session ID of a copy session with the copy type “remote copy” at the local site (in the storage apparatus itself).

The remote REC session ID is a session ID of a copy session with the copy type “remote copy” at the remote site (in the other storage apparatus). The local volume ID is a volume ID of a copy source volume located at the local site (in the storage apparatus itself). The local snapshot volume ID is a volume ID of a volume that stores a snapshot of the copy source volume located at the local site (located in the storage apparatus itself).

The remote volume ID is a volume ID of a copy destination volume located at the remote site (in the other storage apparatus). The remote snapshot volume ID is a volume ID of a volume that stores a snapshot of the copy destination volume located at the remote site (located in the other storage apparatus).

The primary flag is a flag indicating whether the storage apparatus is a copy source of remote copying. A primary flag “TRUE” indicates that the storage apparatus is a copy source. A primary flag “FALSE” indicates that the storage apparatus is a copy destination. The local box ID is an identifier for identifying the storage apparatus. The remote box ID is an identifier for identifying the other storage apparatus.

Next, information stored in the session relationship table 500 (S) included in the storage apparatus 102 will be described.

FIG. 5B is a table illustrating an example of information stored in the session relationship table 500 (S). In FIG. 5B, the session relationship table 500 (S) stores a relationship between copy sessions created when data backup is performed between the storage apparatuses 101 and 102.

Details of the session relationship table 500 (S) are similar to those of the session relationship table 500 (P), and thus, a description thereof will be omitted.

### (Example of Functional Configuration of Storage Apparatus 101)

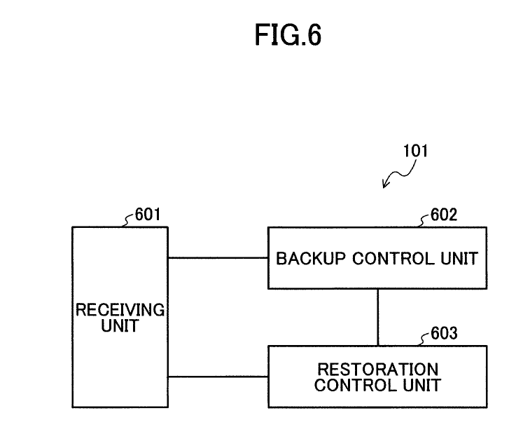

FIG. 6 is a block diagram illustrating an example of a functional configuration of the storage apparatus 101. In FIG. 6, the storage apparatus 101 includes a receiving unit 601, a backup control unit 602, and a restoration control unit 603. The receiving unit 601, the backup control unit 602, and the restoration control unit 603 function as a controller. To be more specific, functions of the receiving unit 601 through the restoration control unit 603 are implemented by causing the CPU 121 to execute a program stored in the memory 122 of the node 120 included in the storage apparatus 101 or by the I/F 123. Processing results obtained from the functional units are stored in a memory such as the memory 122 and the disk 130. It is noted that when the storage apparatus 101 includes a plurality of nodes 120, the functional units are implemented by a node 120, called a master node, of the plurality of nodes 120, for example.

The receiving unit 601 receives an instruction to back up a copy source volume. The instruction is to back up data of the copy source volume of a copy source storage apparatus onto a copy destination volume of a copy destination storage apparatus. The copy source volume is, for example, the volume (P-V) of the storage apparatus 101 illustrated in FIG. 2. Also, the copy destination volume is, for example, the volume (S-V) of the storage apparatus 102 illustrated in FIG. 2.

The instruction to back up the copy source volume includes, for example, a box ID of the copy source storage apparatus, a volume ID of the copy source volume, a box ID of the copy destination storage apparatus, and a volume ID of the copy destination volume. The receiving unit 601 receives the instruction to back up the copy source volume from the user terminal 103 illustrated in FIG. 1.

In the following, an example in which the volume (P-V) of the storage apparatus 101 is regarded as a copy source volume and the volume (S-V) of the storage apparatus 102 is regarded as a copy destination volume will be described. Also, in an initial state, it is assumed that an initial copy from the volume (P-V) to the volume (S-V) is completed.

Upon receiving an instruction to back up the volume (P-V), the backup control unit 602 creates a volume (S-Snap) in the copy destination storage apparatus. Also, the backup control unit 602 creates a volume (P-Snap) in the copy source storage apparatus. Then, the backup control unit 602 starts remote copying from the volume (P-Snap) to the volume (S-V).

The volume (P-Snap) is a first volume on which to create a snapshot of the volume (P-V), which is the copy source volume. The volume (S-Snap) is a second volume on which to create a snapshot of the volume (S-V), which is the copy destination volume.

In the following, the snapshot of the volume (P-V) may be referred to as a “first snapshot”, and the snapshot of the volume (S-V) may be referred to as a “second snapshot”.

To be more specific, for example, the backup control unit 602 transmits an instruction to create a volume (S-Snap) to the storage apparatus 102, which is the copy destination storage apparatus. Upon receiving the instruction to create the volume (S-Snap), the storage apparatus 102 creates the volume (S-Snap). Then, the storage apparatus 102 creates a second snapshot of the volume (S-V). Also, the storage apparatus 102 indicates the volume ID of the volume (S-Snap) to the storage apparatus 101.

Also, the backup control unit 602 creates a volume (P-Snap), and creates a first snapshot of the volume (P-V) on the volume (P-Snap). Next, the backup control unit 602 generates a remote copy session from the volume (P-Snap) to the volume (S-V). Then, the backup control unit 602 calculates a difference between the volume (P-Snap) and the volume (S-V) and starts copying differential data.

In the storage apparatus 101, upon the first snapshot being created, copy session information 410-1 is stored in the copy session table 400 (P). Also, in the storage apparatus 102, upon the second snapshot being created, copy session information 420-2 is stored in the copy session information 420-2.

Also, upon the remote copy session from the volume (P-Snap) to the volume (S-V) being generated, copy session information 410-2 is stored in the copy session table 400 (P) of the storage apparatus 101. Also, copy session information 420-1 is stored in the copy session table 400 (S) of the storage apparatus 102.

Also, upon the remote copy session from the volume (P-Snap) to the volume (S-V) being generated, the session relationship tables 500 (P) and 500 (S) are created in the respective storage apparatuses 101 and 102. Information set in the tables is obtained by the storage apparatuses 101 and 102 communicating with each other.

Further, upon copying the differential data from the volume (P-Snap) to the volume (S-V) being completed, “equivalent” is set in the “phase” field of the copy session information 410-2 in the copy session table 400 (P). Also, “equivalent” is set in the “phase” field of the copy session information 420-1 in the copy session table 400 (S).

The receiving unit 601 receives an instruction to restore a copy source volume. The instruction is to restore data of the copy source volume of a copy source storage apparatus. The instruction to restore the copy source volume includes, for example, a box ID of the copy source storage apparatus and a volume ID of the copy source volume. To be more specific, the receiving unit 601 receives the instruction to restore the copy source volume from the user terminal 103.

In the following, an example in which the “volume (P-V) of the storage apparatus 101” is regarded as a copy source volume to be restored will be described. In this case, the restoration instruction includes a box ID “A” of the copy source storage apparatus and a volume ID “1” of the copy source volume. In a case where a hardware failure such as a disk fault occurs, restoration is performed after a fault part is recovered, for example, after a disk is replaced.

Upon receiving an instruction to restore the volume (P-V), the restoration control unit 603 decides a restoration source volume from the volume (P-Snap), the volume (S-V), and the volume (S-Snap). The restoration source volume is a volume used to restore data of the volume (P-V). The restoration control unit 603 performs control that copies data of the decided restoration source volume to the volume (P-V), such that the data of the volume (P-V) is restored.

To be more specific, upon receiving an instruction to restore the volume (P-V), the restoration control unit 603 determines the status of the first snapshot. For example, the status of the first snapshot can be determined by referring to the “status” filed in the copy session table 400 (P) illustrated in FIG. 4A. The “status” is updated in accordance with the status of a copy session. For example, if a hardware failure occurs while a copy session is in progress, the “status” becomes “error”. Thus, the restoration control unit 603 can determine the status of each copy session by referring to the “status” field in the copy session table 400 (P).

More specifically, for example, by referring to the copy session table 400 (P), the restoration control unit 603 identifies copy session information 410-1 in which the volume ID “1” of the copy source volume included in the restoration instruction is set in the “copy source ID” field and “snapshot” is set in the “copy type” field. Then, the restoration control unit 603 refers to the identified copy session information 410-1 and determines that the status of the first snapshot is normal when the “status” indicates “active”. Conversely, when the “status” indicates “error”, the restoration control unit 603 determines that the status of the first snapshot is abnormal.

Restoration Source Volume=Volume (P-Snap)

When it is determined that the status of the first snapshot is normal, the restoration control unit 603 decides the volume (P-Snap) as the restoration source volume. When the volume (P-Snap) is decided as the restoration source volume, the data of the volume (P-V) is restored by copying data of the volume (P-Snap) to the volume (P-V).

Accordingly, when there is no hardware failure such as a disk fault occurring in the storage apparatus 101, and the status of the first snapshot created on the volume (P-Snap) is normal, the volume (P-V) can be restored from the volume (P-Snap) located at the same site.

Conversely, when it is determined that the status of the first snapshot is abnormal, the restoration control unit 603 determines whether copying data of the first snapshot onto the volume (S-V) is completed and the volume (S-V) is equivalent to the volume (P-Snap).

More specifically, for example, by referring to the copy session table 400 (P), the restoration control unit 603 identifies copy session information 410-2 in which a volume ID “11” of the volume (S-V) is set in the “copy destination ID” field and “remote copy” is set in the “copy type” field. Then, the restoration control unit 603 refers to the identified copy session information 410-2 and determines that the volume (S-V) is equivalent to the volume (P-Snap) when the “status” indicates “equivalent”. Conversely, when the “status” indicates “copying”, the restoration control unit 603 determines that the volume (S-V) is not equivalent to the volume (P-Snap).

Based on a determination result, the restoration control unit 603 decides the restoration source volume from the volume (S-V) and the volume (S-Snap). More specifically, for example, when it is determined that the status of the volume (S-V) is equivalent, the restoration control unit 603 decides the volume (S-V) as the restoration source volume. Conversely, when it is determined that the status of the volume (S-V) is not equivalent, the restoration control unit 603 decides the volume (S-Snap) as the restoration source volume.

Restoration Source Volume=Volume (S-V)

When the volume (S-V) is decided as the restoration source volume, the restoration control unit 603 first performs control that causes the direction of remote copying from the volume (P-Snap) to the volume (S-V) to be reversed. Then, the restoration control unit 603 performs remote copying of data of the volume (S-V) onto the volume (P-Snap). When the remote copying of the data of the volume (S-V) to the volume (P-Snap) is completed, data of the volume (P-Snap) is copied to the volume (P-V) such that the data of the volume (P-V) is restored.

Accordingly, when a hardware failure such as a disk fault occurs in the storage apparatus 101 and the previous remote copying from the volume (P-Snap) to the volume (S-V) is completed, the volume (P-V) can be restored from the volume (S-V).

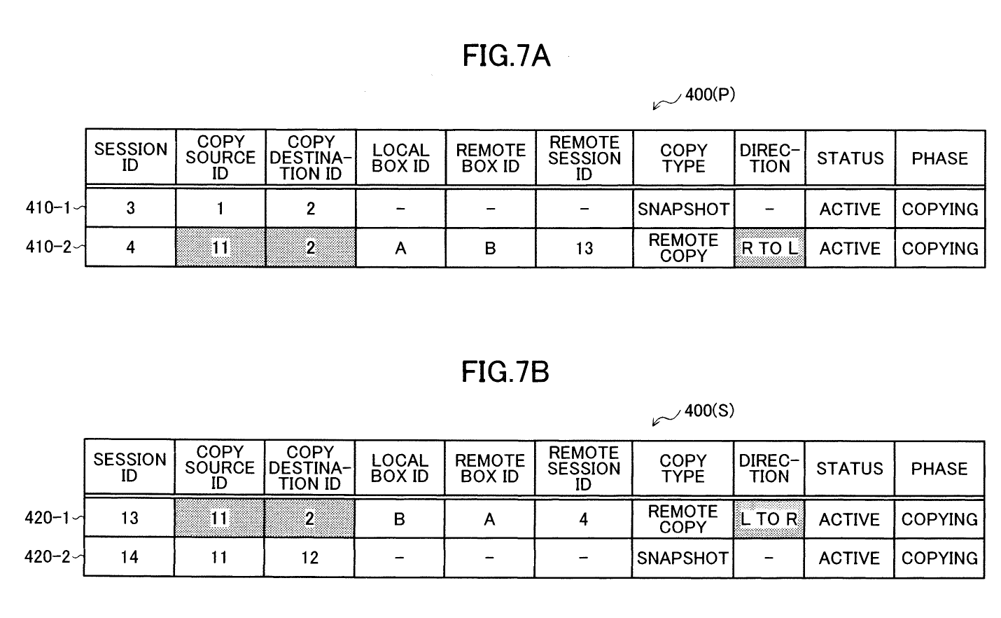

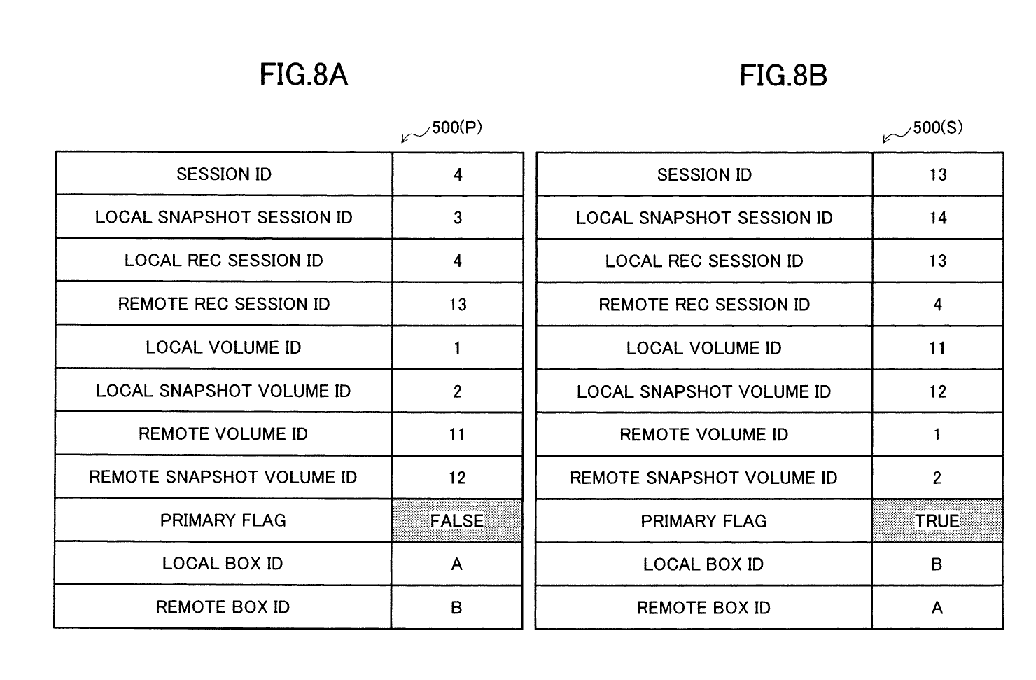

Referring now to FIGS. 7A and 7B and FIGS. 8A and 8B, examples of the updated tables 400 and 500 when the volume (S-V) is decided as the restoration source volume will be described.

FIGS. 7A and 7B are tables illustrating examples of the updated copy session tables 400. FIGS. 8A and 8B are tables illustrating examples of the updated session relationship tables 500. As illustrated in FIGS. 7A and 7B, when the direction of the remote copying from the volume (P-Snap) to the volume (S-V) is reversed, the copy session information 410-2 in the copy session table 400 (P) is updated, and also the copy session information 420-1 in the copy session table 400 (S) is updated.

To be more specific, in the copy session information 410-2, the copy source ID and the copy destination ID are switched, and the direction is changed from “L to R” to “R to L”. In the copy session information 420-1, the copy source ID and the copy destination ID are switched, and the direction is changed from “R to L” to “L to R”.

Also, as illustrated in FIGS. 8A and 8B, upon the direction of the remote copying from the volume (P-Snap) to the volume (S-V) being reversed, the primary flag in the session relationship table 500 (P) is changed to “FALSE”. Also, the primary flag in the session relationship table 500 (S) is changed to “TRUE”.

In this way, the data of the volume (P-V) can be restored from the volume (S-V) without changing the session IDs. Accordingly, the copy sessions can be viewed by the user as if the copy sessions are continuously performed with the same session IDs.

Further, when copying the data of the volume (P-Snap) to the volume (P-V) is completed, the restoration control unit 603 causes the direction of the remote copying from the volume (S-V) to the volume (P-Snap) to be reversed. In this way, the restoration control unit 603 resumes the remote copying from the volume (P-Snap) to the volume (S-V).

As a result, data backup of the volume (P-V) can be resumed, and the storage system 100 can be returned to normal operation. In this case, the information stored in the tables 400 and 500 illustrated in FIGS. 7A and 7B and FIGS. 8A and 8B is changed to the information stored in the tables 400 and 500 illustrated in FIGS. 4A and 4B and FIGS. 5A and 5B.

Restoration Source Volume=Volume (S-Snap)

When the volume (S-Snap) is decided as the restoration source volume, the restoration control unit 603 changes remote copying from the volume (P-Snap) to the volume (S-V) to remote copying from the volume (S-Snap) to the volume (P-V). Namely, the restoration control unit 603 restores the data of the volume (P-V) by copying data of the volume (S-Snap) to the volume (P-V).

Accordingly, when a failure such as a disk fault occurs in the storage apparatus 101 while the remote copying from the volume (P-Snap) to the volume (S-V) is being performed, the volume (P-V) can be restored from the volume (S-Snap).

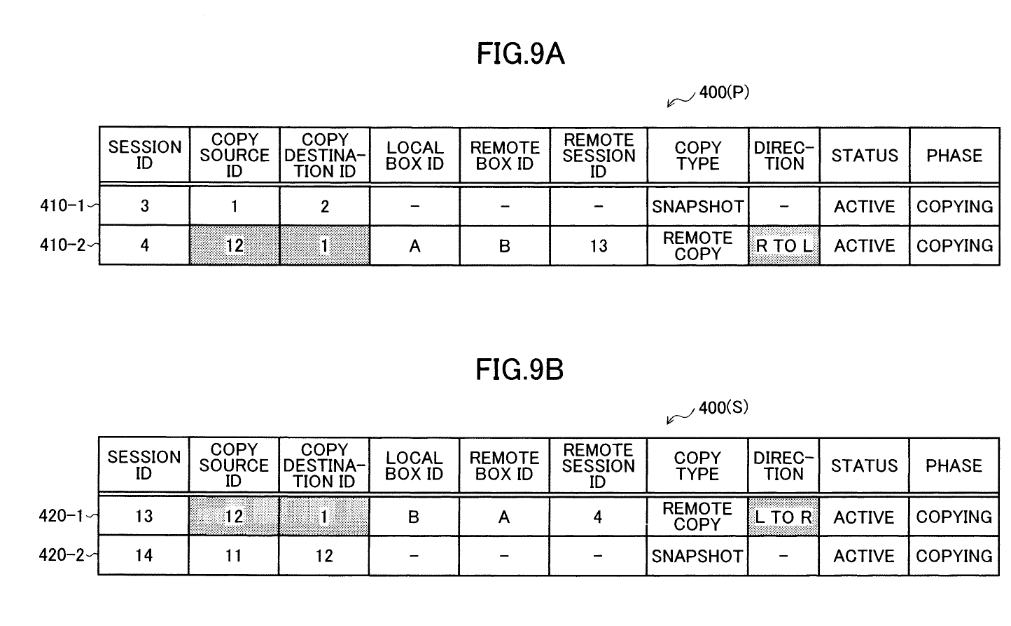

Referring now to FIGS. 9A and 9B, examples of the updated tables 400 when the volume (S-Snap) is decided as the restoration source volume will be described. Examples of the updated session relationship tables 500 when the volume (S-Snap) is decided as the restoration source volume are similar to those illustrated in FIGS. 8A and 8B, and thus, a description thereof will be omitted.

FIGS. 9A and 9B are tables illustrating examples of the updated copy session tables 400. As illustrated in FIGS. 9A and 9B, when the remote copying from the volume (P-Snap) to the volume (S-V) is changed to the remote copying from the volume (S-Snap) to the volume (P-V), the copy session information 410-2 in the copy session table 400 (P) is updated.

To be more specific, in the copy session information 410-2, the copy source ID is changed to a volume ID “12” of the volume (S-Snap), the copy destination ID is changed to the volume ID “1” of the volume (P-V), and the direction is changed from “L to R” to “R to L”. Also, in the copy session information 420-1, the copy source ID is changed to the volume ID “12” of the volume (S-Snap), the copy destination ID is changed to the volume ID “1” of the volume (P-V), and the direction is changed from “R to L” to “L to R”.

In this way, the data of the volume (P-V) can be restored from the volume (S-Snap) without changing the session IDs. Accordingly, the copy sessions can be viewed by the user as if the copy sessions are continuously performed with the same session IDs.

Further, when copying the data of the volume (S-Snap) to the volume (P-V) is completed, the restoration control unit 603 changes to the remote copying from the volume (P-Snap) to the volume (S-V). As a result, the restoration control unit 603 resumes the remote copying from the volume (P-Snap) to the volume (S-V).

As a result, data backup of the volume (P-V) can be resumed, and the storage system 100 can be returned to normal operation. In this case, the information stored in the tables 400 and 500 is changed to those illustrated in FIGS. 4A and 4B and FIGS. 5A and 5B.

It is noted that, upon receiving an instruction to restore the volume (P-V), the restoration control unit 603 may determine whether copying data of the first snapshot to the volume (S-V) is completed and the volume (S-V) is equivalent to the volume (P-Snap). Then, based on a determination result, the restoration control unit 603 may decide the restoration source volume from the volume (S-V) and the volume (S-Snap).

Also, in the above description, the functional units are included in the storage apparatus 101, which is the copy source storage apparatus. However, the functional units may be included in the storage apparatus 102, which is the copy destination storage apparatus.

### (Backup Process Performed by Storage Apparatus 101)

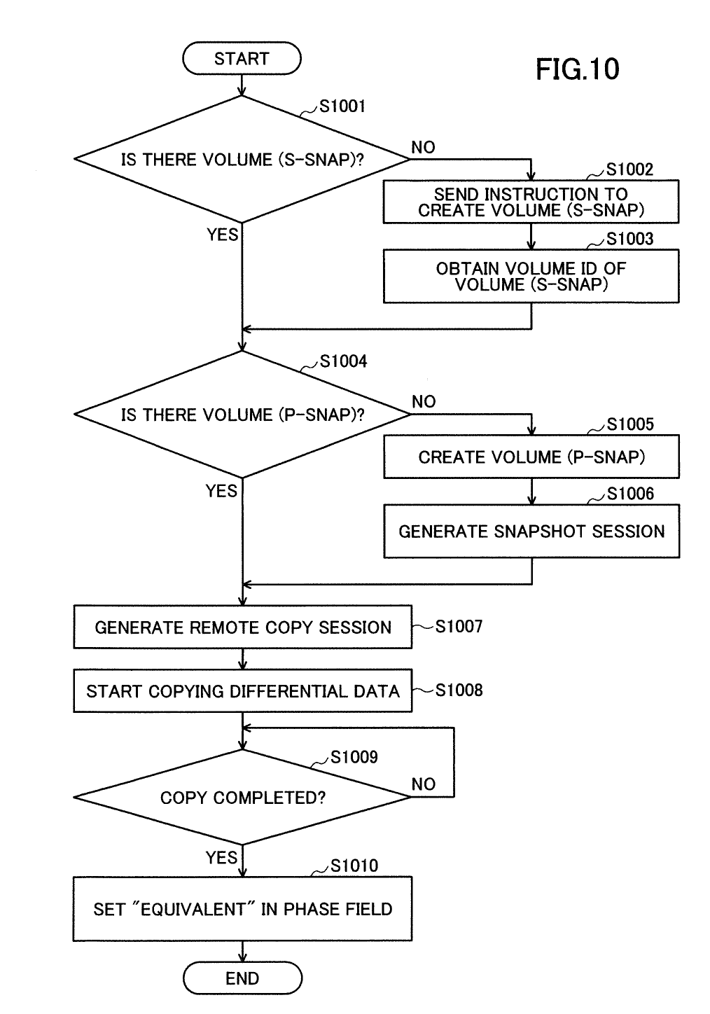

Next, referring to FIG. 10, a backup process performed by the storage apparatus 101 will be described. The backup process is performed by the storage apparatus 101 in accordance with an instruction to back up a copy source volume, or at specified time intervals (such as at 1 hour-intervals or 1 day-intervals). In FIG. 10, the volume (P-V) of the storage apparatus 101 is regarded as a copy source volume, and the volume (S-V) of the storage apparatus 102 is regarded as a copy destination volume. Also, in an initial state, an initial copy from the volume (P-V) to the volume (S-V) is assumed to be completed.

FIG. 10 is a flowchart illustrating an example of a backup process performed by the storage apparatus 101. In the flowchart illustrated in FIG. 10, the storage apparatus 101 determines whether there is a volume (S-Snap) (step S1001).

To be more specific, for example, the storage apparatus 101 refers to the session relationship table 500 (P) and determines that there is a volume (S-Snap) when a volume ID is set in the “remote snapshot volume ID” field. Conversely, when a volume ID is not set in the “remote snapshot volume ID” field, the storage apparatus 101 determines that there is no volume (S-Snap). Further, the storage apparatus 101 may determine whether there is a volume (S-Snap) by inquiring of the storage apparatus 102, which is the copy destination storage apparatus.

When there is a volume (S-Snap) (yes in step S1001), the storage apparatus 101 causes the process to proceed to step S1004. When there is no volume (S-Snap) (no in step S1001), the storage apparatus 101 sends an instruction to create a volume (S-Snap) to the storage apparatus 102 (step S1002).

Upon receiving the instruction to create a volume (S-Snap) from the storage apparatus 101, the storage apparatus 102 creates a volume (S-Snap). Then, the storage apparatus 102 generates a snapshot session from the volume (S-V) to the volume (S-Snap), and creates a second snapshot of the volume (S-V) on the volume (S-Snap). As a result, copy session information 420-2 is stored in the copy session table 400 (S) of the storage apparatus 102. Also, the storage apparatus 102 indicates a volume ID of the volume (S-Snap) to the storage apparatus 101.

Then, the storage apparatus 101 obtains the volume ID of the volume (S-Snap) from the storage apparatus 102 (step S1003). Next, the storage apparatus 101 determines whether there is a volume (P-Snap) in the storage apparatus 101 itself (step S1004).

When there is a volume (P-Snap) (yes in step S1004), the storage apparatus 101 causes the process to proceed to step S1007. Conversely, when there is no volume (P-Snap) (no in step S1004), the storage apparatus 101 creates a volume (P-Snap) in the storage apparatus 101 itself (step S1005).

Then, the storage apparatus 101 generates a snapshot session from the volume (P-V) to the volume (P-Snap), and creates a first snapshot of the volume (P-V) on the volume (P-Snap) (step S1006). As a result, copy session information 410-1 is stored in the copy session table 400 (P) of the storage apparatus 101.

Next, the storage apparatus 101 generates a remote copy session from the volume (P-Snap) to the volume (S-V) (step S1007). As a result, copy session information 410-2 is stored in the copy session table 400 (P) of the storage apparatus 101. Also, copy session information 420-1 is stored in the copy session table 400 (S) of the storage apparatus 102. Further, session relationship tables 500 (P) and 500 (S) are created in the respective storage apparatuses 101 and 102. At this time, the volume ID of the volume (S-Snap) obtained in step S1003 is set in the “remote snapshot volume ID” field of the session relationship table 500 (P).

Then, the storage apparatus 101 calculates a difference between the volume (P-Snap) and the volume (S-V), and starts copying differential data (step S1008). Next, the storage apparatus 101 determines whether copying the differential data is completed (step S1009).

The storage apparatus 101 waits until copying the differential data is completed (no in step S1009). When copying the differential data is completed (yes in step S1009), the storage apparatus 101 sets “equivalent” in the “phase” field of the copy session information 410-2 in the copy session table 400 (P) (step S1010), and ends the process illustrated in this flowchart.

Accordingly, it is possible to back up data of the volume (P-V) while preventing I/O performance of the volume (P-V) from being affected. Further, it is also possible to back up data of the volume (S-V) at the remote site by taking into account a communication failure during remote copying.

In step S1009, when copying the differential data is completed, “equivalent” is set in the “phase” field of the copy session information 420-1 in the copy session table 400 (S) of the storage apparatus 102. Also, in a case where the backup process is started to be performed in accordance with a backup instruction from a user, the storage apparatus 101 may send an error notification when copying the differential data is not completed after a predetermined period of time elapses.

### (Restoration Process Performed by Storage Apparatus 101)

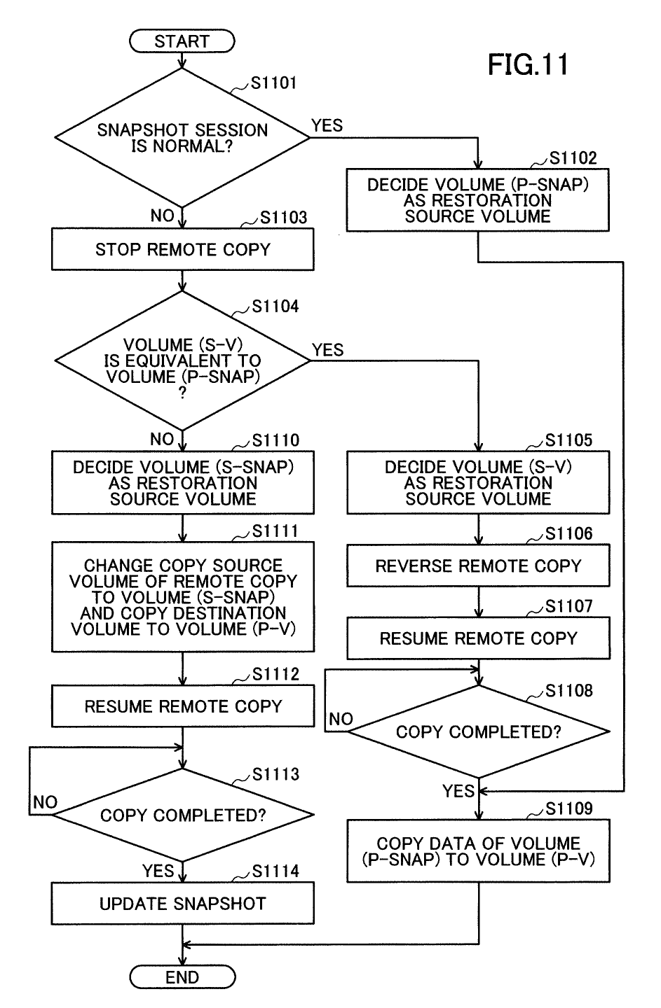

Next, referring to FIG. 11, a restoration process performed by the storage apparatus 101 will be described. The restoration process is performed by the storage apparatus in accordance with an instruction to back up a copy source volume. In FIG. 11, the volume (P-V) of the storage apparatus 101 is regarded as a copy source volume to be restored.

FIG. 11 is a flowchart illustrating an example of a restoration process performed by the storage apparatus 101. In the flowchart illustrated in FIG. 11, the storage apparatus 101 refers to the copy session table 400 (P), and determines whether the status of the snapshot session from the volume (P-V) to the volume (P-Snap) is normal (step S1101).

When it is determined that the status of the snapshot session is normal (yes in step S1101), the storage apparatus 101 decides the volume (P-Snap) as the restoration source volume (step S1102), and causes the process to proceed to step.

Conversely, when it is determined that the status of the snapshot session is abnormal (no in step S1101), the storage apparatus 101 stops remote copying from the volume (P-Snap) to the volume (S-V) (step S1103). Then, the storage apparatus 101 refers to the copy session table 400 (P), and determines whether the volume (S-V) is equivalent to the volume (P-Snap) (step S1104).

When it is determined that the volume (S-V) is equivalent to the volume (P-Snap) (yes in S1104), the storage apparatus 101 decides the volume (S-V) as the restoration source volume (step S1105). Next, the storage apparatus 101 causes the direction of the remote copying from the volume (P-Snap) to the volume (S-V) to be reversed (step S1106).

Then, the storage apparatus 101 resumes the remote copying (step S1107). Next, the storage apparatus 101 determines whether remote copying from the volume (S-V) to the volume (P-Snap) is completed (step S1108). The storage apparatus 101 waits until the remote copying is completed (no in S1108).

When the remote copying is completed (yes in step S1108), the storage apparatus 101 copies data of the volume (P-Snap) to the volume (P-V) (step S1109), and ends the process illustrated in the flowchart.

In step S1104, when it is determined that the volume (S-V) is not equivalent to the volume (P-Snap) (no in S1104), the storage apparatus 101 decides the volume (S-Snap) as the restoration source volume (step S1110).

Next, the storage apparatus 101 changes the copy source volume of the remote copying to the volume (S-Snap) and the copy destination volume to the volume (P-V) (step S1111). Then, the storage apparatus 101 resumes the remote copying (step S1112).

Next, the storage apparatus 101 determines whether the remote copying from the volume (S-Snap) to the volume (P-V) is completed (step S1113). The storage apparatus 101 waits until the remote copying is completed (no in step S1113).

When the remote copying is completed (yes in step S1113), the storage apparatus 101 causes a snapshot of the volume (P-V) to be updated and stored in the volume (P-Snap) (step S1114), and ends the process illustrated in the flowchart.

Accordingly, when restoring data of the volume (P-V), it is possible to automatically decide a restoration source volume from the volume (S-V) and the volume (S-Snap) in order to reduce the user's burden of restoration work.

### (Post-Restoration Process Performed by Storage Apparatus 101)

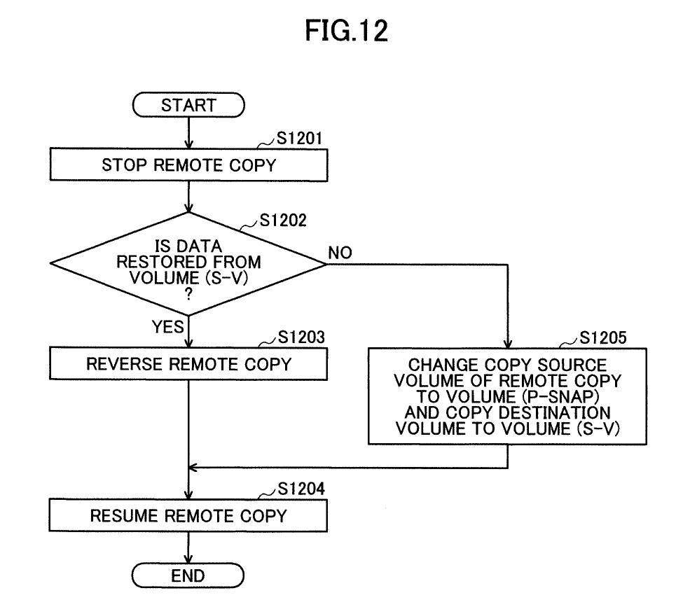

Next, referring to FIG. 12, a post-restoration process performed by the storage apparatus 101 will be described. The post-restoration process is performed by the storage apparatus 101 after the restoration process illustrated in FIG. 11 is finished, such that data backup is resumed and the storage system 100 is returned to normal operation. For example, the post-restoration process is performed in accordance with an instruction (an instruction to return the storage system to normal operation) from the user.

FIG. 12 is a flowchart illustrating an example of a post-restoration process performed by the storage apparatus 101. In the flowchart of FIG. 12, the storage apparatus 101 first stops remote copying between the storage apparatus 101 and the storage apparatus 102 (step S1201). Next, the storage apparatus 101 determines whether the data is restored from the volume (S-V) (step S1202).

When the data is restored from the volume (S-V) (yes in S1202), the storage apparatus 101 causes the direction of the remote copying from the volume (S-V) to the volume (P-Snap) to be reversed (step S1203). Then, the storage apparatus 101 resumes the remote copying from the volume (P-Snap) to the volume (S-V) (step S1204), and ends the process illustrated in the flowchart.

In S1202, when the data is restored from the volume (S-Snap) (no in S1202), the storage apparatus 101 changes the copy source volume of the remote copying to the volume (P-Snap) and the copy destination volume to the volume (S-V) (step S1205), and causes the process to proceed to step S1204.

Accordingly, data backup of the volume (P-V) can be resumed and the storage system 100 can be returned to normal operation. It is noted that, when the data is restored from the volume (P-Snap), data backup of the volume (P-V) can be resumed and the storage system can be returned to normal operation after the restoration process illustrated in FIG. 11 is completed.

As described above, according to the storage apparatus 101 of the embodiment, upon receiving an instruction to restore the volume (P-V), the status of the first snapshot created on the volume (P-Snap) can be automatically determined. Also, according to the storage apparatus 101, when the status of the first snapshot is determined to be normal, the volume (P-Snap) can be decided as the restoration source volume.

Thus, when there is no hardware failure such as a disk fault occurring in the storage apparatus 101, and the status of the first snapshot created on the volume (P-Snap) is normal, data can be restored from the volume (P-Snap) located at the same site. For example, when a failure due to human error such as data deletion occurs, data can be restored from the volume (P-Snap) located at the same site.

Also, according to the storage apparatus 101, when the status of the first snapshot is determined to be abnormal, it is possible to determine whether copying the first snapshot to the volume (S-V) is completed and the volume (S-V) is equivalent to the volume (P-Snap). Then, according to the storage apparatus 101, the restoration source volume can be decided from the volume (S-V) and the volume (S-Snap) based on a determination result.

Accordingly, depending on whether the previous remote copying from the volume (P-Snap) to the volume (S-V) is completed, the restoration source volume can be switched between the volume (S-V) and the volume (S-Snap).

Also, according to the storage apparatus 101, when the volume (S-V) is equivalent to the volume (P-Snap), the volume (S-V) can be decided as the restoration source volume.

Accordingly, when a failure such as a disk fault occurs in the storage apparatus 101, and the previous remote copying from the volume (P-Snap) to the volume (S-V) is successfully completed, data can be restored from the volume (S-V).

Also, according to the storage apparatus 101, when the volume (S-V) is not equivalent to the volume (P-Snap), the volume (S-Snap) can be decided as the restoration source volume.

Accordingly, when a failure such as a disk fault occurs in the storage apparatus 101 during remote copying from the volume (P-Snap) to the volume (S-V), data can be restored from the volume (S-Snap).

Also, according to the storage apparatus 101, when the volume (S-V) is decided as the restoration source volume, data of the volume (S-V) can be copied to the volume (P-Snap) by causing the direction of remote copying from the volume (P-Snap) to the volume (S-V) to be reversed. Then, according to the apparatus 101, when remote copying from the volume (S-V) to the volume (P-Snap) is completed, data of the volume (P-Snap) can be copied to the volume (P-V) such that data of the volume (P-V) can be restored.

Accordingly, when data of the volume (P-V) is restored from the volume (S-V), the data can be restored without changing session IDs. Accordingly, copy sessions can be viewed by the user as if the copy sessions are continuously performed with the same session IDs.

Also, according to the storage apparatus 101, when copying data of the volume (P-Snap) to the volume (P-V) is completed, the remote copying from the volume (P-Snap) to the volume (S-V) can be resumed by causing the direction of the remote copying from the volume (S-V) to the volume (P-Snap) to be reversed.

Accordingly, data backup of the volume (P-V) can be resumed and the storage system 100 can be returned to normal operation. Also, the user's burden of restoration work can be reduced as compared to when the direction of remote copying is manually changed.

Also, according to the storage apparatus 101, when the volume (S-Snap) is decided as the restoration source volume, the remote copying from the volume (P-Snap) to the volume (S-V) is changed to remote copying form the volume (S-Snap) to the volume (P-V), such that data of the volume (S-Snap) can be copied to the volume (P-V), and thus, data of the volume (P-V) can be restored.

Accordingly, when data of the volume (P-V) is restored from the volume (S-Snap), the data can be restored without changing session IDs.

Accordingly, copy sessions can be viewed by the user as if the copy sessions are continuously performed with the same session IDs, thus allowing data management to become easy.

Also, according to the storage apparatus 101, when copying data of the volume (S-Snap) to the volume (P-V) is completed, the remote copying from the volume (S-Snap) to the volume (P-V) is changed to the remote copying from the volume (P-Snap) to the volume (S-V). As a result, the remote copying from the volume (P-Snap) to the volume (S-V) can be resumed.

Accordingly, data backup of the volume (P-V) can be resumed and the storage system 100 can be returned to normal operation. Also, the user's burden of restoration work can be reduced as compared to when the direction of remote copying is manually changed.

According to the storage system 100 and the storage apparatus 101 of the embodiment, a restoration source volume from which to restore data of the volume (P-V) can be decided depending on what failure occurs in what situation. Accordingly, when data of the volume (P-V) is restored, it is not required for the user to check the status of each volume one by one, in order to determine from which volume to restore the data. Thus, it is possible to reduce the user's burden of restoration work.

A control method described in the above embodiment can be achieved by causing a computer such as a personal computer or a workstation to execute a control program that is prepared beforehand. The control program is recorded in a computer-readable recording medium such as a hard disk, flexible disk, a compact disc (CD)-ROM, a magneto-optical (MO) disk, a digital versatile disc (DVD), or a universal serial bus (USB) memory, and is executed by being read from the recording medium by the computer. Also, the control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that the various changes, substitutions, and alterations could be made hereto without departing from the spirit and scope of the invention.

What is claimed is:

1. A storage apparatus comprising:
a memory; and
a processor coupled to the memory and configured to,
upon reception of an instruction to restore a copy source volume of a copy source storage apparatus that includes the copy source volume and a first volume on which a first snapshot of the copy source volume is created, make a determination as to whether remote copying of data of the first snapshot to a copy destination volume of a copy destination storage apparatus is completed and the copy destination volume is equivalent to the first volume, the copy destination storage apparatus including the copy destination volume onto which the remote copying is performed and including a second volume on which a second snapshot of the copy destination volume is created, and
based on a result of the determination, decide, from the copy destination volume and the second volume, a restoration source volume from which data of the copy source volume is restored.

2. The storage apparatus according to claim 1, wherein the processor is configured to decide the copy destination volume as the restoration source volume when the copy destination volume is determined to be equivalent to the first volume.

3. The storage apparatus according to claim 1, wherein the processor is configured to decide the second volume as the restoration source volume when the copy destination volume is determined not to be equivalent to the first volume.

4. The storage apparatus according to claim 1, wherein the processor is configured to
determine a status of the first snapshot upon reception of the instruction to restore the copy source volume, and
decide the first volume as the restoration source volume when the status of the first snapshot is determined to be normal, and determine whether the copy destination volume is equivalent to the first volume when the status of the first snapshot is determined to be abnormal.

5. The storage apparatus according to claim 1, wherein the processor is configured to perform control that copies data of the decided restoration source volume to the copy source volume.

6. The storage apparatus according to claim 5, wherein, when the copy destination volume is determined as the restoration source volume, the processor is configured to perform a copy of data of the copy destination volume to the first volume by causing a direction of the remote copying from the first volume to the copy destination volume to be reversed, and is configured to perform a copy of data of the first volume to the copy source volume when remote copying the copy destination volume to the first volume is completed.

7. The storage apparatus according to claim 5, wherein, when the second volume is determined as the restoration source volume, the processor is configured to perform a copy of data of the second volume to the copy source volume by causing the remote copying from the first volume to the copy destination volume to be changed to remote copying from the second volume to the copy source volume.

8. The storage apparatus according to claim 6, wherein, when the copy of the data of the first volume to the copy source volume is completed, the processor is configured to resume the remote copying from the first volume to the copy destination volume by causing a direction of the remote copying from the copy destination volume to the first volume to be reversed.

9. The storage apparatus according to claim 7, wherein, when the copy of the data of the second volume to the copy source volume is completed, the processor is configured to resume the remote copying from the first volume to the copy destination volume by causing the remote copying from the second volume to the copy source volume to be changed to the remote copying from the first volume to the copy destination volume.

10. A non-transitory recording medium having stored therein a program for causing a computer to execute a process comprising:
upon reception of an instruction to restore a copy source volume of a copy source storage apparatus that includes the copy source volume and a first volume on which a first snapshot of the copy source volume is created, making a determination as to whether remote copying of data of the first snapshot to a copy destination volume of a copy destination storage apparatus is completed and the copy destination volume is equivalent to the first volume, the copy destination storage apparatus including the copy destination volume onto which the remote copying is performed and including a second volume on which a second snapshot of the copy destination volume is created, and
based on a result of the determination, deciding, from the copy destination volume and the second volume, a restoration source volume from which data of the copy source volume is restored.
